(19) United States
(12) Patent Application Publication
(10) Pub. No.: US 2025/0038206 A1
(43) Pub. Date: Jan. 30, 2025

(54) ARTIFICIAL GRAPHITE NEGATIVE ELECTRODE MATERIAL, METHOD FOR PREPARING THE SAME, AND LITHIUM-ION BATTERY

(71) Applicant: HUNAN ZHONGKE SHINZOOM CO., LTD., Ningxiang Changsha, Hunan (CN)

(72) Inventor: Zhiyong WANG, Ningxiang Changsha, Hunan (CN)

(73) Assignee: HUNAN ZHONGKE SHINZOOM CO., LTD., Ningxiang Changsha, Hunan (CN)

(21) Appl. No.: 18/707,422

(22) PCT Filed: Oct. 27, 2022
(86) PCT No.: PCT/CN2022/128001

§ 371 Date: May 3, 2024

(30) Foreign Application Priority Data
Nov. 8, 2021 (CN) 202111313132.6

(51) Int. Cl. H01M 4/587; C01B 32/205; C01B 32/21; H01M 4/02; H01M 10/0525

(52) U.S. Cl. CPC H01M 4/587; C01B 32/205; C01B 32/21; H01M 10/0525; C01P 2006/12; C01P 2006/40; H01M 2004/021; H01M 2004/027

(57) ABSTRACT

An artificial graphite negative electrode material, a method for preparing the same, and a lithium-ion battery are provided. The method includes: obtaining the artificial graphite negative electrode material by heating up artificial graphite in a protective atmosphere and injecting an active gas. The artificial graphite negative electrode material is obtained by heating up artificial graphite in a protective atmosphere and injecting an active gas.

### CROSS-REFERENCE TO RELATED APPLICATION(S)

This application is a National Stage of International Application No. PCT/CN2022/128001, field Oct. 27, 2022, which claims priority to Chinese Patent Application No. 202111313132.6, filed Nov. 8, 2021, the entire disclosures of which are hereby incorporated by reference.

### TECHNICAL FIELD

This application belongs to the technical field of lithium-ion battery, and particularly to an artificial graphite negative electrode material, a method for preparing the same, and a lithium-ion battery.

### BACKGROUND

With the continuous development of the new energy industry, the development of the electrochemical energy storage system is also promoted continuously. A graphite negative electrode material has become the most successful negative electrode material in terms of commercialization because of its strong stability. As the currently most widely used negative electrode material for lithium-ion batteries, the graphite negative electrode material relies on processes of insertion and extraction of lithium ions between graphite layers to complete storage and release of energy. However, a theoretical specific capacity of graphite is only 372 mAh/g, and a specific capacity of the currently most widely used artificial graphite material is only 350 mAh/g to 360 mAh/g, which will seriously affect the overall energy density of the battery. How to improve the performance of a material on a material side has become an important direction for the development of high-energy-density lithium-ion batteries in the future. Researchers can increase the capacity of the negative electrode material of the lithium battery to a very high level by adding silicon, tin, or other high-capacity negative electrode materials, but for the sake of the overall stability of a battery core, these materials should not be added too much. However, even if a small amount of the high-capacity negative electrode material is added, the cycling performance of the material will be affected seriously, resulting in a deterioration of the overall life of the battery. Therefore, a more ideal solution is to further make improvement on the basis of the graphite material.

For the artificial graphite prepared after graphitization of raw coke, the degree of graphitization is relatively low, and some SP³ carbon exist on its surface. The specific capacity can be increased by removing SP³ carbon.

CN 101746744 A relates to a method for preparing a carbon negative electrode material of a lithium-ion battery, which includes the following processes: (1) obtaining precursor by placing a defined weight of needle coke and pitch selected and solvent in a container, heating up to a temperature of 10° C. to 100° C. while stirring for 1 h to 20 h, and removing the solvent; and (2) obtaining the carbon negative electrode material of the lithium-ion battery by placing the precursor into a high temperature furnace, heating up to a temperature of 500° C. to 1000° C. at 1° C./min to 6° C./min in an inert atmosphere, sintering for 5 h to 24 h, and performing graphitization heat treatment at 2800° C. to 3000° C. after cooling. The carbon negative electrode material prepared in such way has a specific gram specific capacity ranging from 340 mAh/g to 345 mAh/g. The negative electrode material obtained by coating the pitch with only needle-shaped artificial graphite has a relatively small specific gram specific capacity, since the compacted density of the material is relatively limited (generally below 1.55g/cm³), because the needle-shaped artificial graphite itself has a certain particle aspect ratio. If the compacted density exceeds 1.55g/cm³, the cycle life generally decays quickly. Moreover, the pitch being coated with only the needle-shaped artificial graphite will lead to limited effective contact between material particles, resulting in a relatively poor low-temperature performance and rate performance of the material.

CN 1691374 A relates to preparing an artificial graphite negative electrode material by coating a coating material dissolved in a solvent on a surface of artificial graphite, the artificial graphite negative electrode material prepared in such way has a relatively low specific surface area and a relatively high first Coulombic efficiency, but a large amount of solvent is introduced during the preparation process, resulting in a complicated process and relatively large environmental harm.

CN 102509778 A relates to a lithium-ion battery negative electrode material and a method for preparing the same. The lithium-ion battery negative electrode material is composed of silicon oxide particles, graphite particles, and expanded graphite particles, and the silicon oxide particles, the graphite particles, and the expanded graphite particles are coated by carbon. The method includes the following: (1) obtaining a primary mixed material by placing a defined amount of silicon oxide, graphite, and expanded graphite weighed into a planetary ball mill, grinding them in vacuum or an inert atmosphere, and mixing them evenly; (2) obtaining a secondary mixed material by placing a defined amount of carbon source precursor weighed into the planetary ball mill, grinding the carbon source precursor together with the primary mixed material in vacuum or an inert atmosphere, and mixing the carbon source precursor with the primary mixed material evenly; and (3) obtaining the lithium-ion battery negative electrode material by sintering in an inert atmosphere the secondary mixed material taken out and carbonizing the carbon source precursor. The silicon monoxide negative electrode material prepared by the above-mentioned existing technical methods is dedicated to pursuing high capacity, generally 1000 mAh/g, but its cycling performance is poor. A capacity retention after 100 cycles is only 50% ˜60% of the initial capacity, so it is difficult to achieve industrialization.

Therefore, how to further increase the specific gram specific capacity of the graphite negative electrode material without reducing other electrochemical performances has become an urgent technical problem to-be-solved.

### SUMMARY

The following is a summary of the solutions of the DETAILED DESCRIPTION in the disclosure. This summary is not intended to limit the protection scope of the appended claims.

In a first aspect, the disclosure provides a method for preparing an artificial graphite negative electrode material. The method includes: obtaining the artificial graphite negative electrode material by heating up artificial graphite in a protective atmosphere and injecting an active gas.

In a second aspect, the disclosure provides an artificial graphite negative electrode material. The artificial graphite negative electrode material is obtained by heating up artificial graphite in a protective atmosphere and injecting an active gas. In the artificial graphite negative electrode material, 0.2≤I_{D}/I_{G}≤0.35, and a specific surface area ranges from 2 m²/g to 5 m²/g.

In a third aspect, the disclosure provides a lithium-ion battery. The lithium-ion battery contains an artificial graphite negative electrode material obtained by heating up artificial graphite in a protective atmosphere and injecting an active gas. In the artificial graphite negative electrode material, 0.2≤I_{D}/I_{G}≤0.35, and a specific surface area ranges from 2 m²/g to 5 m²/g.

### DETAILED DESCRIPTION

Hereinafter, technical solutions of the disclosure will be further depicted through exemplary embodiments. Those skilled in the art should understand that embodiments described below are to help understand the disclosure and should not be construed as limiting the disclosure.

In view of the above deficiencies of the related art, the disclosure provides an artificial graphite negative electrode material, a method for preparing the same, and a lithium-ion battery. In the disclosure, the active gas can react with carbon structures on a surface of an artificial graphite material to modify the surface of the graphite material, where the modifying refers to reaction of SP³ carbon and part of SP² carbon with the active gas, which can effectively reduce inactive components and enhance an ion transport property, thereby further improving a kinetic performance and a capacity of the material.

In order to solve the above technical problems, the disclosure adopts the following technical solutions.

In a first aspect, the disclosure provides a method for preparing an artificial graphite negative electrode material. The method includes: obtaining the artificial graphite negative electrode material by heating up artificial graphite in a protective atmosphere and injecting an active gas.

The active gas of the disclosure needs to be able to react with SP³ carbon on the surface of the artificial graphite material, and no protective atmosphere is needed when injecting the active gas, while the protective atmosphere needs to be injected when heating up.

In the disclosure, the active gas can react with SP³ carbon and part of SP² carbon on the surface of the artificial graphite material, which can effectively reduce defect structures on the surface of the graphite material, so as to reduce inactive components in the material and further increase a capacity of the material, without destroying SP² lattice structures inside the graphite, thereby achieving maintenance of a bulk cycle characteristic, a first cycle efficiency, and other performances of the artificial graphite material.

In the disclosure, heating is first performed under the protective atmosphere, which is beneficial to controlling the artificial graphite to react at a limited temperature while eliminating other side reactions.

In some embodiments, the active gas includes any one or a combination of at least two of oxygen-containing gas, water vapor, or carbon dioxide.

These types of active gases provided in the disclosure can controllably react with carbon.

In some embodiments, a content of oxygen in the oxygen-containing gas is less than or equal to 15%.

In some embodiments, the method for preparing the artificial graphite negative electrode material further includes: obtaining the artificial graphite by performing graphitization treatment on easily graphitized carbon material.

In some embodiments, the easily graphitized carbon material includes any one or a combination of at least two of petroleum coke, pitch coke, or needle coke.

After a coke material, as a raw material, undergoes ultra-high temperature graphitization, carbon inside the coke material will undergo directional rearrangement to form a layered regular structure. However, due to the difference in the size of molecular masses of unit structures that form the coke, the size of internal crystal domains of the formed graphite structure may be different during internal molecular rearrangement. In addition, some volatile small molecular structures will be enriched on the surface of the graphite material to form SP³ defect structures, which is detrimental to lithium storage performances of the graphite material, resulting in a reduction in a capacity of the material.

In some embodiments, in the artificial graphite, I_{D}/I_{G}≤0.08, and a specific surface area ≤1.5 m²/g. For example, I_{D}/I_{G} is 0.08, 0.07, 0.06, 0.05, 0.04, etc., and the specific surface area is 1.5 m²/g, 1.4 m²/g, 1.2 m²/g, 1 m²/g, 0.9 m²/g, 0.8 m²/g, etc.

In some embodiments, a temperature of the graphitization treatment ranges from 2900° C. to 3300° C., such as 2900° C., 3000° C., 3100° C., 3200° C., 3300° C., etc.

In some embodiments, a duration of the graphitization treatment ranges from 10 h to 30 h, such as 10 h, 13 h, 15 h, 18 h, 20 h, 23 h, 25 h, 28 h, 30 h, etc.

In some embodiments, the protective atmosphere includes any one or a combination of at least two of nitrogen, argon, or helium.

In some embodiments, when heating up, a heating rate ranges from 2° C./min to 10° C./min, such as 2° C./min, 3° C./min, 4° C./min, 5° C./min, 6° C./min, 7° C./min, 8° C./min, 9° C./min, 10° C./min, etc.

In some embodiments, a temperature after heating up ranges from 900° C. to 1200° C., such as 900° C., 950° C., 1000° C., 1050° C., 1100° C., 1150° C., 1200° C., etc.

In the disclosure, the reaction between the active gas and the artificial graphite can be realized when the reaction is carried out at the above temperature. If the temperature is too low, it is difficult to react with SP^{3;} if the temperature is too high, a reaction speed will be too fast to be controlled.

In some embodiments, a gas flow rate of the active gas ranges from 2 L/min to 10 L/min, such as 2 L/min, 3 L/min, 4 L/min, 5 L/min, 6 L/min, 7 L/min, 8 L/min, 9 L/min, 10 L/min, etc.

In some embodiments, a duration for injecting the active gas ranges from 10 h to 40 h, such as 3 h, 5 h, 8 h, 10 h, 13 h, 15 h, 18 h, 20 h, 23 h, 25 h, 28 h, 30 h, etc.

In the disclosure, with cooperation of the gas flow rate of the active gas and the duration for injecting the active gas, activation of part of SP² carbon on the surface of the graphite can be realized effectively, and the active gas can react with SP³ carbon on the surface of the artificial graphite material, which can maintain a bulk cycle characteristic, a first cycle efficiency, and other performances of the graphite material, while increasing a kinetic performance and a specific capacity of the material.

In some embodiments, the method further includes: obtaining the artificial graphite by performing graphitization treatment on easily graphitized carbon material for 10 h to 30 h at a temperature of 2900° C. to 3300° C., where in the artificial graphite, I_{D}/I_{G}≤0.08, and a specific surface area ≤1.5 m²/g. Obtaining the artificial graphite negative electrode material by heating up the artificial graphite in the protective atmosphere and injecting the active gas includes: obtaining the artificial graphite negative electrode material by: heating up the artificial graphite in the protective atmosphere to reach a temperature of 900° C. to 1200° C. at a heating rate of 2° C./min to 10° C./min and injecting the active gas for 10 h to 40 h at a gas flow rate of 2 L/min to 10 L/min, where the active gas includes any one or a combination of at least two of oxygen-containing gas, water vapor, or carbon dioxide; and a content of oxygen in the oxygen-containing gas is less than or equal to 15%.

In a second aspect, the disclosure provides an artificial graphite negative electrode material. The artificial graphite negative electrode material is obtained by heating up artificial graphite in a protective atmosphere and injecting an active gas. In the artificial graphite negative electrode material, 0.2<I_{D}/I_{G}≤0.35, and a specific surface area ranges from 2 m²/g to 5 m²/g. For example, the I_{D}/I_{G} is 0.2, 0.22, 0.25, 0.28, 0.3, 0.32, 0.35, etc., and the specific surface area is 2 m²/g, 2.5 m²/g, 3 m²/g, 3.5 m²/g, 4 m²/g, 4.5 m²/g, 5 m²/g, etc.

Compared with the conventional artificial graphite, the artificial graphite negative electrode material of the disclosure has a significantly higher proportion of SP² hybrid structures, thereby increasing a capacity of the material without destroying a bulk cycle characteristic, a first cycle efficiency, and other performances of the material.

In some embodiments, the active gas includes any one or a combination of at least two of oxygen-containing gas, water vapor, or carbon dioxide; and a content of oxygen in the oxygen-containing gas is less than or equal to 15%.

In some embodiments, the artificial graphite is obtained by performing graphitization treatment on easily graphitized carbon material, where in the artificial graphite, I_{D}/I_{G} ≤0.08, and a specific surface area ≤1.5 m²/g.

In some embodiments, the easily graphitized carbon material includes any one or a combination of at least two of petroleum coke, pitch coke, or needle coke; a temperature of the graphitization treatment ranges from 2900° C. to 3300° C.; and a duration of the graphitization treatment ranges from 10 h to 30 h.

In some embodiments, the protective atmosphere includes any one or a combination of at least two of nitrogen, argon, or helium.

In some embodiments, when heating up, a heating rate ranges from 2° C./min to 10° C./min; and a temperature after heating up ranges from 900° C. to 1200° C.

In some embodiments, a gas flow rate of the active gas ranges from 2 L/min to 10 L/min; and a duration for injecting the active gas ranges from 10 h to 40 h.

In some embodiments, the artificial graphite is obtained by performing graphitization treatment on easily graphitized carbon material for 10 h to 30 h at a temperature of 2900° C. to 3300° C., where in the artificial graphite, I_{D}/I_{G}<0.08, and a specific surface area ≤1.5 m²/g; and the artificial graphite negative electrode material is specifically obtained by: heating up the artificial graphite in the protective atmosphere to reach a temperature of 900° C. to 1200° C. at a heating rate of 2° C./min to 10° C./min and injecting the active gas for 10 h to 40 h at a gas flow rate of 2 L/min to 10 L/min, where the active gas includes any one or a combination of at least two of oxygen-containing gas, water vapor, or carbon dioxide, and a content of oxygen in the oxygen-containing gas is less than or equal to 15%.

In a third aspect, the disclosure provides a lithium-ion battery. The lithium-ion battery contains an artificial graphite negative electrode material obtained by heating up artificial graphite in a protective atmosphere and injecting an active gas. In the artificial graphite negative electrode material, 0.2≤I_{D}/I_{G}≤0.35, and a specific surface area ranges from 2 m²/g to 5 m²/g.

In some embodiments, the artificial graphite negative electrode material is obtained by: heating up artificial graphite in a protective atmosphere to reach a temperature of 900° C. to 1200° C. at a heating rate of 2° C./min to 10° C./min and injecting an active gas for 10 h to 40 h at a gas flow rate of 2 L/min to 10 L/min, where the active gas includes any one or a combination of at least two of oxygen-containing gas, water vapor, or carbon dioxide; and a content of oxygen in the oxygen-containing gas is less than or equal to 15%.

In some embodiments, the artificial graphite is obtained by performing graphitization treatment on easily graphitized carbon material for 10 h to 30 h at a temperature of 2900° C. to 3300° C., where in the artificial graphite, I_{D}/I_{G}≤0.08, and a specific surface area ≤1.5 m²/g.

In some embodiments, the protective atmosphere includes any one or a combination of at least two of nitrogen, argon, or helium.

Compared with the existing technology, the disclosure has the following advantageous effects.

In the disclosure, the active gas preferentially reacts with SP³ defect structures on the surface of the artificial graphite material, which can reduce inactive components in the material and further increase a capacity of the material, without destroying the internal structure of the graphite, thereby achieving maintenance of a bulk cycle characteristic, a first cycle efficiency, and other performances of the artificial graphite material. For the battery of the disclosure, a discharge specific capacity can reach more than 353.2 mAh/g at 0.1 C, a first cycle efficiency can reach more than 94.9%, a capacity retention can reach more than 96.7% after 100 cycles, and fast charging performance at 2 C/0.2 C can reach more than 24.2%. By further regulating the gas flow rate and the temperature, for the battery of the disclosure, the discharge specific capacity can reach more than 360.5 mAh/g at 0.1 C, the first cycle efficiency can reach more than 96.9%, the capacity retention can reach more than 98.4% after 100 cycles, and the fast charging performance at 2 C/0.2 C can reach more than 33.6%.

Other aspects will become apparent after reading and understanding the DETAILED DESCRIPTION.

### First Embodiment

This embodiment provides an artificial graphite negative electrode material.

A method for preparing the artificial graphite negative electrode material is as follows.

(1) Artificial graphite is obtained by performing graphitization treatment on petroleum coke for 25 h at a temperature of 3000° C.

(2) The artificial graphite obtained in operation (1) is placed into a tube furnace, the artificial graphite is heated up to 1000° C. at a heating rate of 5° C./min in an argon atmosphere, and carbon dioxide is injected for 20 h at a gas flow rate of 5 L/min.

### Second Embodiment

This embodiment provides an artificial graphite negative electrode material.

A method for preparing the artificial graphite negative electrode material is as follows.

(1) Artificial graphite is obtained by performing graphitization treatment on needle coke for 15 h at a temperature of 3300° C.

(2) The artificial graphite obtained in operation (1) is placed into a tube furnace, the artificial graphite is heated up to 1200° C. at a heating rate of 10° C./min in a nitrogen atmosphere, and water vapor is injected for 5 h at a gas flow rate of 10 L/min.

### Third Embodiment

This embodiment provides an artificial graphite negative electrode material.

A method for preparing the artificial graphite negative electrode material is as follows.

(1) Artificial graphite is obtained by performing graphitization treatment on needle coke for 15 h at a temperature of 3300° C.

(2) The artificial graphite obtained in operation (1) is placed into a tube furnace, and the artificial graphite negative electrode material is obtained by heating up the artificial graphite to 1200° C. at a heating rate of 10° C./min in a nitrogen atmosphere and injecting oxygen for 40 h at a gas flow rate of 2 L/min.

### Fourth Embodiment

The difference between this embodiment and the first embodiment lies that: a duration for injecting carbon dioxide in this embodiment is 2 h. Other operations and parameters involved in the method are consistent with these of the first embodiment.

### Fifth Embodiment

The difference between this embodiment and the first embodiment lies that: a duration for injecting carbon dioxide in this embodiment is 50 h. Other operations and parameters involved in the method are consistent with these of the first embodiment.

### Sixth Embodiment

The difference between this embodiment and the first embodiment lies that: in operation (2) of this embodiment, a temperature after heating up is 800° C. Other operations and parameters involved in the method are consistent with these of the first embodiment.

### Seventh Embodiment

The difference between this embodiment and the first embodiment lies that: in

operation (2) of this embodiment, a temperature after heating up is 1300° C. Other operations and parameters involved in the method are consistent with these of the first embodiment.

### First Comparative Embodiment

This comparative embodiment provides an artificial graphite negative electrode material.

The difference between this comparative embodiment and the first embodiment lies that: operation (2) is not performed in this comparative embodiment. Other operations and parameters involved in the method are consistent with these of the first embodiment.

### Second Comparative Embodiment

This comparative embodiment provides an artificial graphite negative electrode material.

The difference between this comparative embodiment and the first embodiment lies that: operation (2) is replaced with an operation of adding 0.5% silicon in this comparative embodiment.

The artificial graphite negative electrode materials obtained through the first to seventh embodiments and the first comparative embodiment are dispersed on a stage, and Raman tests are conducted with a Raman analyzer.

The artificial graphite negative electrode materials obtained through the first to seventh embodiments and the first comparative embodiment are placed in a container, and the specific surface area is tested with a microphone tester.

A electrode piece is prepared as a positive electrode using the artificial graphite negative electrode material provided in each of the first to seventh embodiments and the first comparative embodiment, which meets the following formula: C:SBR:CMC:SP=95.5:2:1.5:1, and a lithium metal piece serves as a negative electrode. A button battery is prepared and then subjected to electrochemical performance testing. The results are shown in Table 1. Table 1 also shows the Raman test I_{D}/I_{G} and the specific surface area of the artificial graphite negative electrode material provided in each of the first to seventh embodiments and the first comparative embodiment.

Test conditions: test a capacity at a rate of 0.1 C, test a capacity retention after 100 cycles, and test a fast charging performance at a rate of 2 C and a rate of 0.2 C.

TABLE 1

| | | Specific | Discharge | First | | Fast charging |
|---|---|---|---|---|---|---|
| | | surface | specific | cycle | Capacity | performance |
| | | area | capacity | efficiency | retention | at 2 C/0.2 C |
| | I_{D}/I_{G} | (m²/g) | (mAh/g) | (%) | (%) | (%) |
| First | 0.23 | 2.9 | 364.3 | 97.9 | 98.4 | 33.6 |
| embodiment | | | | | | |
| Second | 0.28 | 3.2 | 360.5 | 96.9 | 98.7 | 34.1 |
| embodiment | | | | | | |
| Third | 0.31 | 3.6 | 360.8 | 96.9 | 99.1 | 35.5 |
| embodiment | | | | | | |
| Fourth | 0.12 | 1.9 | 353.6 | 95.0 | 98.5 | 24.2 |
| embodiment | | | | | | |
| Fifth | 0.37 | 4.5 | 358.1 | 96.2 | 97.9 | 35.7 |
| embodiment | | | | | | |
| Sixth | 0.15 | 1.7 | 354.2 | 95.4 | 98.2 | 27.4 |
| embodiment | | | | | | |
| Seventh | 0.36 | 4.8 | 359.5 | 96.6 | 96.7 | 35.1 |
| embodiment | | | | | | |
| First | 0.09 | 1.5 | 353.4 | 95.0 | 98.4 | 22.4 |
| comparative | | | | | | |
| embodiment | | | | | | |
| Second | 0.09 | 1.6 | 367.6 | 93.1 | 89.7 | 23.9 |
| comparative | | | | | | |
| embodiment | | | | | | |

It can be seen from the data results of the first embodiment, the fourth embodiment, and the fifth embodiment that, if the duration for injecting the active gas is too short, it is not conducive to removing of the SP³ hybrid structures. Conversely, if the duration for injecting the active gas is too long, too many SP² hybrid structures will be further reacted off, resulting in a too large specific surface area, and further damaging the first cycle efficiency and cycling performance.

It can be seen from the data results of the first embodiment, the sixth embodiment, and the seventh embodiment that, if the temperature after heating up is too low, it is not conducive to the progress of the reaction. Conversely, if the temperature after heating up is too high, it will cause the reaction to be uncontrolled, resulting in excessive reaction of the SP² hybrid structure.

It can be seen from the data results of the first embodiment and the first comparative embodiment that, the artificial graphite negative electrode material provided in the disclosure has a more excellent electrochemical performance and a higher specific capacity.

It can be seen from the data results of the first embodiment and the second comparative embodiment that, the method provided in the disclosure can further improve the capacity of the material without adding materials that are not conducive to cycling, thereby achieving maintenance of a bulk cycle characteristic, a first cycle efficiency, and other performances of the artificial graphite material, while improving a fast charging performance.

In sum, in the disclosure, the active gas can react with SP³ defect structures on the surface of the artificial graphite material, which can effectively reduce the defect structures on the surface of the graphite material, so as to reduce inactive components in the material, thereby enhancing an ion transport property, and further improving a kinetic performance and a capacity of the material. The battery of the disclosure has a discharge specific capacity more than 353.2 mAh/g at 0.1 C, a first cycle efficiency more than 94.9%, a capacity retention after 100 cycles more than 96.7%, and a fast charging performance at 2 C/0.2 C more than 24.2%. By further regulating the gas flow and the temperature, the battery of the disclosure has the discharge specific capacity more than 360.5 mAh/g at 0.1 C, the first cycle efficiency more than 96.9%, the capacity retention after 100 cycles more than 98.4%, and the fast charging performance at 2 C/0.2 C more than 33.6%.

While the objectives, technical solutions, and advantageous effects of the disclosure have been described in detail in connection with the exemplary embodiments, it is to be understood that the above is only specific embodiments of the disclosure and is not intended to limit the disclosure. Any modifications, equivalent substitutions, and improvements made without departing from the spirit and scope of the disclosure should be encompassed into the protection scope of the disclosure.

1. A method for preparing an artificial graphite negative electrode material, comprising:
obtaining the artificial graphite negative electrode material by heating up artificial graphite in a protective atmosphere and injecting an active gas.

2. The method for preparing the artificial graphite negative electrode material of claim 1, wherein the active gas comprises any one or a combination of at least two of oxygen-containing gas, water vapor, or carbon dioxide.

3. The method for preparing the artificial graphite negative electrode material of claim 1, further comprising:
obtaining the artificial graphite by performing graphitization treatment on easily graphitized carbon material, wherein
in the artificial graphite, I_{D}/I_{G}≤0.08, and a specific surface area ≤1.5 m²/g.

4. The method for preparing the artificial graphite negative electrode material of claim 3, wherein the easily graphitized carbon material comprises any one or a combination of at least two of petroleum coke, pitch coke, or needle coke.

5. The method for preparing the artificial graphite negative electrode material of claim 1, wherein the protective atmosphere comprises any one or a combination of at least two of nitrogen, argon, or helium.

6. The method for preparing the artificial graphite negative electrode material of claim 1, wherein when heating up, a heating rate ranges from 2° C./min to 10° C./min; and
a temperature after heating up ranges from 900° C. to 1200° C.

7. The method for preparing the artificial graphite negative electrode material of claim 1, wherein a gas flow rate of the active gas ranges from 2 L/min to 10 L/min; and
a duration for injecting the active gas ranges from 10 h to 40 h.

8. The method for preparing the artificial graphite negative electrode material of claim 1 wherein
the method further comprises:
obtaining the artificial graphite by performing graphitization treatment on easily graphitized carbon material for 10 h to 30 h at a temperature of 2900° C. to 3300° C., wherein in the artificial graphite, I_{D}/I_{G}≤0.08, and a specific surface area ≤1.5 m²/g; and
obtaining the artificial graphite negative electrode material by heating up the artificial graphite in the protective atmosphere and injecting the active gas comprises:
obtaining the artificial graphite negative electrode material by: heating up the artificial graphite in the protective atmosphere to reach a temperature of 900° C. to 1200° C. at a heating rate of 2° C./min to 10° C./min and injecting the active gas for 10 h to 40 h at a gas flow rate of 2 L/min to 10 L/min, wherein
the active gas comprises any one or a combination of at least two of oxygen-containing gas, water vapor, or carbon dioxide; and
a content of oxygen in the oxygen-containing gas is less than or equal to 15%.

9. An artificial graphite negative electrode material, wherein the artificial graphite negative electrode material is obtained by heating up artificial graphite in a protective atmosphere and injecting an active gas; wherein in the artificial graphite negative electrode material, 0.2 <I_{D}/I_{G}≤0.35, and a specific surface area ranges from 2 m²/g to 5 m²/g.

10. A lithium-ion battery, containing an artificial graphite negative electrode material obtained by heating up artificial graphite in a protective atmosphere and injecting an active gas, wherein in the artificial graphite negative electrode material, 0.2≤I_{D}/I_{G} ≤0.35, and a specific surface area ranges from 2 m²/g to 5 m²/g.

11. The method for preparing the artificial graphite negative electrode material of claim 2, wherein a content of oxygen in the oxygen-containing gas is less than or equal to 15%.

12. The method for preparing the artificial graphite negative electrode material of claim 3, wherein a temperature of the graphitization treatment ranges from 2900° C. to 3300° C.

13. The method for preparing the artificial graphite negative electrode material of claim 3, wherein a duration of the graphitization treatment ranges from 10 h to 30 h.

14. The artificial graphite negative electrode material of claim 9, wherein the active gas comprises any one or a combination of at least two of oxygen-containing gas, water vapor, or carbon dioxide; and
a content of oxygen in the oxygen-containing gas is less than or equal to 15%.

15. The artificial graphite negative electrode material of claim 9, wherein the artificial graphite is obtained by performing graphitization treatment on easily graphitized carbon material, wherein
in the artificial graphite, I_{D}/I_{G}≤0.08, and a specific surface area ≤1.5 m²/g.

16. The artificial graphite negative electrode material of claim 15, wherein the easily graphitized carbon material comprises any one or a combination of at least two of petroleum coke, pitch coke, or needle coke;
a temperature of the graphitization treatment ranges from 2900° C. to 3300° C.; and
a duration of the graphitization treatment ranges from 10 h to 30 h.

17. The artificial graphite negative electrode material of claim 9, wherein the protective atmosphere comprises any one or a combination of at least two of nitrogen, argon, or helium.

18. The artificial graphite negative electrode material of claim 9, wherein when heating up, a heating rate ranges from 2° C./min to 10° C./min; and
a temperature after heating up ranges from 900° C. to 1200° C.

19. The artificial graphite negative electrode material of claim 9, wherein a gas flow rate of the active gas ranges from 2 L/min to 10 L/min; and
a duration for injecting the active gas ranges from 10 h to 40 h.

20. The artificial graphite negative electrode material of claim 9, wherein
the artificial graphite is obtained by performing graphitization treatment on easily graphitized carbon material for 10 h to 30 h at a temperature of 2900° C. to 3300° C., wherein in the artificial graphite, I_{D}/I_{G}<0.08, and a specific surface area ≤1.5 m²/g; and
the artificial graphite negative electrode material is specifically obtained by: heating up the artificial graphite in the protective atmosphere to reach a temperature of 900° C. to 1200° C. at a heating rate of 2° C./min to 10° C./min and injecting the active gas for 10 h to 40 h at a gas flow rate of 2 L/min to 10 L/min, wherein the active gas comprises any one or a combination of at least two of oxygen-containing gas, water vapor, or carbon dioxide, and a content of oxygen in the oxygen-containing gas is less than or equal to 15%.
